(19) United States
(12) Patent Application Publication
(10) Pub. No.: US 2019/0346934 A1
(43) Pub. Date: Nov. 14, 2019

(54) HEADSET WITH ADJUSTABLE SENSOR

(71) Applicant: LIGHT SPEED AVIATION, INC., Lake Oswego, OR (US)

(72) Inventors: Allan SCHRADER, Lake Oswego, OR (US); Matthew Raymond EVONUK, Tualatin, OR (US); Brian David FROST, Lake Oswego, OR (US)

(21) Appl. No.: 16/407,152

(22) Filed: May 8, 2019

Related U.S. Application Data
(60) Provisional application No. 62/668,803, filed on May 8, 2018.

(51) Int. Cl. G06F 3/01; H04R 1/10; H04R 1/08

(52) U.S. Cl. CPC G06F 3/017; H04R 1/1016; H04R 1/1083; H04R 1/105; H04R 2430/01; H04R 1/08

(57) ABSTRACT

A headset includes a band connected to a hub supporting an earphone and an adjustable sensor mount configured to position a sensor forward of a forward of the tragus of a user. The sensor is movable relative to the hub and may translate and/or rotate to position the sensor in contact with or proximal to skin of the user. The headset may include an over-the-head band, an over-the-ear band, or an eyewear band to support an in-the-ear speaker or earbud. The headset may also include a microphone connected to the hub and/or band. The headset may include a processor or circuitry to process sensor signals to detect blood flow, heart rate, etc. and/or movement, such as jaw movement indicative of talking for use in automatically attenuating or muting an associated microphone.

### CROSS-REFERENCE TO RELATED APPLICATIONS

This application claims the benefit of U.S. provisional application Ser. No. 62/668,803 filed May 8, 2018, the disclosure of which is hereby incorporated in its entirety by reference herein.

### TECHNICAL FIELD

This disclosure relates to a headset having in-the-ear speakers and an adjustable sensor mount to position a sensor forward of the tragus of a user.

### BACKGROUND

Various types of sensors are being used to monitor personal physiological or biometric parameters related to health and/or performance during specified events or time periods, as well as during everyday activities. Monitoring of parameters such as heart rate, blood pressure, respiration rate, oxygen saturation, blood chemistry, blood flow, etc. under various environmental and use conditions presents numerous challenges in providing an acceptable sensor signal for processing. For example, motion artifacts generated by movement of the user and/or sensor during use may decrease accuracy of the resulting signal analysis results if not properly accommodated. Similarly, variation in positioning of the sensor relative to an expected placement, or movement during use may result in decreased accuracy. Changes in ambient conditions, such as variations in ambient light, sound, vibration, etc. may also contribute to noise in the sensor signal.

Sensors have been integrated with earphones and headphones as the ear has been identified as being particularly amenable to photoplythysmography (PPG), or the optical volumetric measurement of blood flow, and similar optical measurements. Pulse oximetry sensors have been integrated into the cushion of circumaural headsets to measure blood oxygen saturation. Earphones, ear buds, headphones, and similar devices provide a convenient form factor that users are generally familiar with and comfortable with positioning of the devices.

### SUMMARY

In one embodiment, a headset includes a band connecting first and second hubs configured to support and position at least one of a speaker, a microphone, and a sensor. Each hub may be fixed to the band A sensor arm may extend from the hub and may be extendable and rotatable relative thereto. The headset may also include a microphone connected to at least one of the band and the hub and a controller coupled to the microphone and the sensor, wherein the controller processes signals from the sensor and the microphone to automatically mute the microphone unless the signals from the sensor indicate jaw movement associated with talking. The headset may also include an error sense microphone coupled to the controller with the controller providing ANR functionality via the speaker.

Embodiments may include a headset having a band, a hub connected to the band, an earphone connected to the hub, and a sensor connected to the hub and configured for movement in at least one direction relative to the hub to be positionable forward of a tragus of a user. Embodiments may also include a second hub connected to the band, a second earphone connected to the second hub, and a second sensor connected to the second hub and configured for movement in at least one direction relative to the hub to be positionable forward of a second tragus of the user. The band may be configured for support by a helix of the user, by an eyewear frame, or as an over-the-head or behind-the-head band. The headset may also include at least one head support connected to at least one of the hub and the band.

Embodiments may also include a headset with an earphone connected to a hub having at least one aperture by an earphone support having an aperture, and a band extending through the apertures of the earphone support and the hub such that the hub and earphone support are rotatable relative to the band. The sensor and/or earphone may be connected to the hub by an extendable arm, which may be rotatable relative to the hub. The sensor may be connected to the extendable arm by a ball-and-socket joint.

Various embodiments of a headset or earphone having an adjustable sensor for positioning forward of the tragus of the user may include components for active noise reduction (ANR), passive hearing protection, audio, and/or voice communications using wired or wireless technology. ANR applications may include at least one driver, error (sense) microphone, an optional voice/speech microphone and/or an optional ambient noise microphone coupled to one or more controllers to provide ANR and voice/speech functions.

One or more embodiments of a headset may include an associated controller having a microprocessor in communication with a sensor configured for positioning in front of the tragus of a user. The sensor may be mounted on an adjustable arm that may rotate and/or translate relative to a hub secured to a band to move the sensor to a desired position on the user and maintain contact between the sensor and the user while delivering a comfortable fit wearing the device. The controller may be programed to analyze signals from the sensor. In one embodiment, the controller is programmed to detect jaw position and/or movement of the user in response to signals from the sensor. User jaw position and/or movement may be used to infer that a user is talking. The controller may provide a gating or attenuation signal to a voice/speech microphone in response to detecting that the user is talking such that the voice/speech microphone signal is automatically attenuated or muted when the user is not talking. User jaw position and/or movement as detected by the sensor may also be used to identify other user behavior, such as chewing or yawning, to distinguish from talking, or to provide a local or remote alert, for example.

Embodiments according to this disclosure may provide one or more advantages. For example, adjustable mounting of a sensor associated with a headset or earphone may allow the user to adjust the position of the sensor relative to the headset to improve signal to noise ratio and resulting accuracy and reliability of the sensor signal. The headset or earphone may provide isolation for the sensor to reduce the effect of environmental factors, such as ambient noise and light, on the sensor signals. Resilient mounting of a sensor may improve skin proximity or contact with the sensor during physical activity, while also improving comfort. Positioning of a biometric sensor in contact with the skin in front of the tragus over at least a portion of the TMJ provides a viable location for measurement of various biometric parameters, such as heartrate, oxygen saturation, blood flow, etc. Positioning of the sensor forward of the tragus within a designated target area using a headset/headphone provides limited location variability from person to person. An adjustable sensor positioning device according to various embodiments facilitates user adjustment and positioning of the sensor in two dimensions for proper placement, with a third-dimension adjustment for comfort and proper skin contact or proximity. Detection of jaw movement using a sensor may be used to provide an automatic attenuation, muting, or gating function for a communication microphone associated with the headset, or to provide local or remote alerts based on inferred behavior associated with jaw position or movements.

The above advantages and other advantages and features will be readily apparent from the following detailed description of the preferred embodiments when taken in connection with the accompanying drawings.

### BRIEF DESCRIPTION OF THE DRAWINGS

FIG. 1 illustrates a representative headset having an adjustable sensor for position in front of the tragus of a user according to one or more embodiments;

FIG. 2 illustrates ear anatomy with a target area forward of the tragus over at least a portion of the temporomandibular joint (TMJ) for positioning of a sensor of a headset according to one or more embodiments;

FIG. 3 illustrates a representative headset having an in-the-ear speaker and adjustable sensor positioned in front of the tragus according to one or more embodiments;

FIG. 4 illustrates a representative earphone or headset with an over-the-ear band according to one or more embodiments;

FIG. 5 illustrates positioning of the embodiment illustrated in FIG. 4 on a user;

FIG. 6 illustrates an eyewear-mounted earphone or headset according to one or more embodiments;

FIG. 7 is a block diagram illustrating operation of a representative control system for a circumaural headset having an adjustable sensor according to one or more embodiments; and

FIG. 8 is a flowchart illustrating operation of a system or method for controlling a circumaural headset having an adjustable sensor according to one or more embodiments.

### DETAILED DESCRIPTION

As required, detailed embodiments are disclosed herein; however, it is to be understood that the disclosed embodiments are merely representative and the claimed subject matter may be embodied in various and alternative forms not explicitly illustrated or described. The figures are not necessarily to scale; some features may be exaggerated or minimized to show details of particular components. Therefore, specific structural and functional details disclosed are not to be interpreted as limiting, but merely as a representative basis for teaching one skilled in the art to variously employ the claimed subject matter.

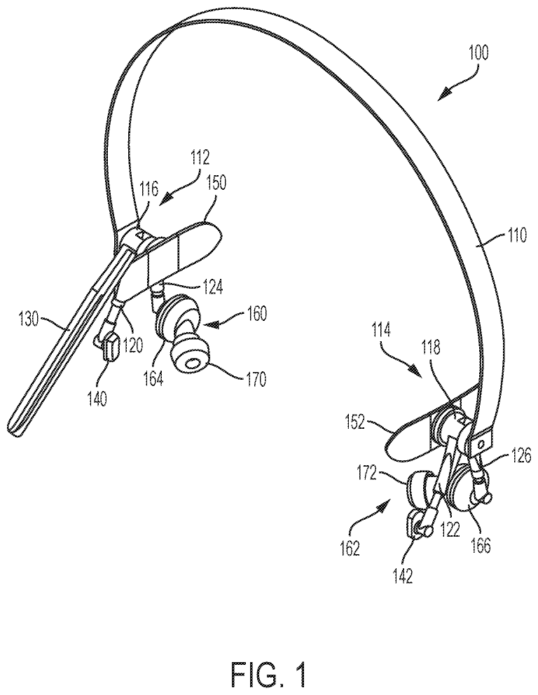

FIGS. 1-3 illustrate a representative headset having an adjustable sensor mount according to one or more embodiments. Headset 100 includes a band 110 connecting right ear assembly 112 and left ear assembly 114. Each ear assembly 112, 114 includes an associated hub 116, 118 connected to band 110. Hubs 116, 118 may be configured for fixed or rotatable connections to band 110 depending on the particular application and implementation. Headband 110 may be configured to be worn over the head or behind the head of the user. Other embodiments may include an over-the-ear band or an eyewear band.

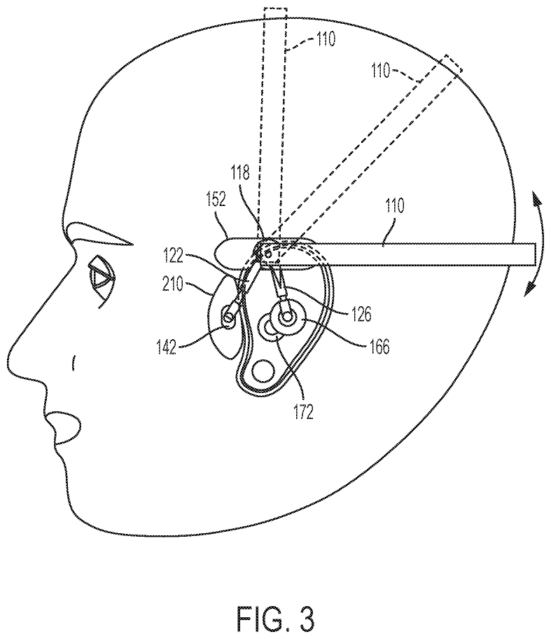

In the embodiment of FIGS. 1 and 3, each hub 116, 118 supports an associated sensor arm 120, 122, and earphone arm 124, 126. Headset 100 may also include a communications microphone 130 supported by hub 116 or hub 118. Microphone 130 is implemented by a wired boom microphone in the representative embodiment illustrated, in other embodiments, headset 100 may communicate with an associated wireless microphone or with a wireless device having a microphone. When included, a microphone may be implemented with or without a boom, on a short boom, integrated into a wired connection, implemented by an optical comparator system, etc. Some embodiments do not include an associated microphone.

Headset 100 includes at least one sensor 140, 142 secured to an associated sensor arm 120, 122 extending from hub 112, 114, respectively. Various representative embodiments may he described with reference to a biometric or physiological sensor. However, those of ordinary skill in the art will recognize that one or both sensors 140, 142 may be implemented by various types of sensors that may employ chemical, electrical, and/or optical technology to provide detection or measurement of various environmental conditions as well as user characteristics and/or movements. As such, the representative embodiments described and illustrated are not limited to biometric or physiologic sensors. Other examples of sensors may include acoustic sensors, accelerometers, and gyroscopes, for example.

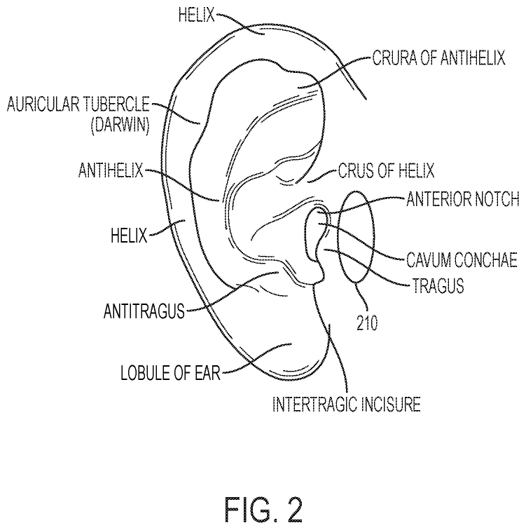

As described in greater detail below, the adjustable sensor arms 120, 122 are configured to be movable in at least one direction or dimension to adjust a position of associated sensors 140,142 within a target region 210 (FIG. 2) of the user, either in contact with the user or near contact, such as within 0-5 mm of the user, for example. In various embodiments, the target area or region 210 is generally forward of a tragus of the user as generally indicated in the ear anatomy of FIG. 2, and may extend above or below the tragus. In one or more embodiments, target region 210 extends between 5 mm-50 mm in front of the tip of the tragus, and within 25 mm above the helix to 25 mm below the ear lobe (or lobule of the ear).

For embodiments employing a biometric or physiologic sensor, sensors 140, 142 may be implemented by any of a number of commercially available sensors that may be used to provide signals indicative of physiological parameters or characteristics of the user/wearer such as heart rate, blood pressure, respiration rate, oxygen saturation, blood chemistry, blood flow, etc. In one embodiment, signals from sensors 140, 142 are used to detect jaw position and/or movement of the user that may indicate talking, chewing, yawning, etc. Jaw position signals may be used to provide a gating signal to provide an automatic attenuation or muting function for microphone 130 that mutes microphone 130 except when the user is talking.

In various embodiments, sensor arms 120 and/or 122 may be rotatable about a corresponding hub 116, 118. Adjustable arms 120 and/or 122 may also be extendable toward or away from the associated hub 116, 118. Sensors 140, 142 may also be mounted for pivoting or rotation relative to associated sensor arms 120, 122.

As also illustrated in FIGS. 1-3, headset 100 may include head supports or stabilizers 150, 152 connected to associated hubs 116, 118. In one or more embodiments, band 110 may be connected on the inside of stabilizers 150, 152, or between stabilizers 150, 152 and hubs 116, 118.

Each earphone arm 124, 126 of headset 100 may include an associated earphone assembly 160, 162 having a speaker and associated elastomeric cover 170, 172 to provide a seal within the outer portion of the ear canal of the user. Earphone assemblies 160, 162 may include associated housings 164, 166 connected to associated earphone arms 124, 126 via a fixed, rotatable, or ball-and-socket connection, for example. Earphone arms 124, 126 may be extendable relative to associated hubs 116, 118. Housings 164, 166 may be configured to rest on the concha of the user, and may contain electronics or circuitry for the associated speakers. Earphone assemblies 160, 162 may also include error sense microphones and/or ambient microphones in ANR embodiments.

FIG. 2 illustrates ear anatomy with a target area 210 forward of the tragus over at least a portion of the temporomandibular joint (TMJ) for positioning of a biometric sensor 126 of a circumaural headset according to one or more embodiments. As used throughout this description, an adjustable sensor provides movement of the sensor relative to the support structure in at least one direction. In sonic embodiments, movement may be provided in non-orthogonal directions, or along one or more of an x-axis, y-axis, and z-axis direction where the x-axis is defined by moving forward in the direction of the face or rearward in the direction of the back of the head (horizontally), the y-axis is defined by moving in the direction of the top of the head (upward) or the neck (vertically, downward), and the z-axis is defined by moving toward the head or away from the head.

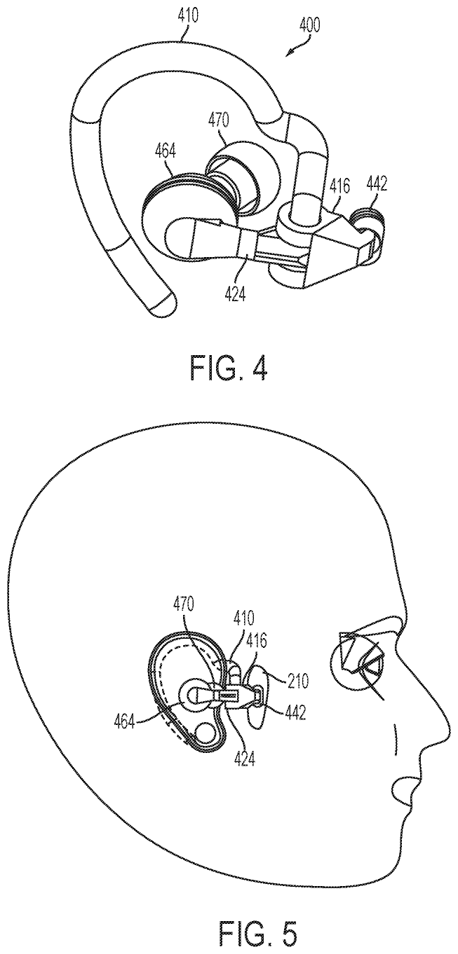

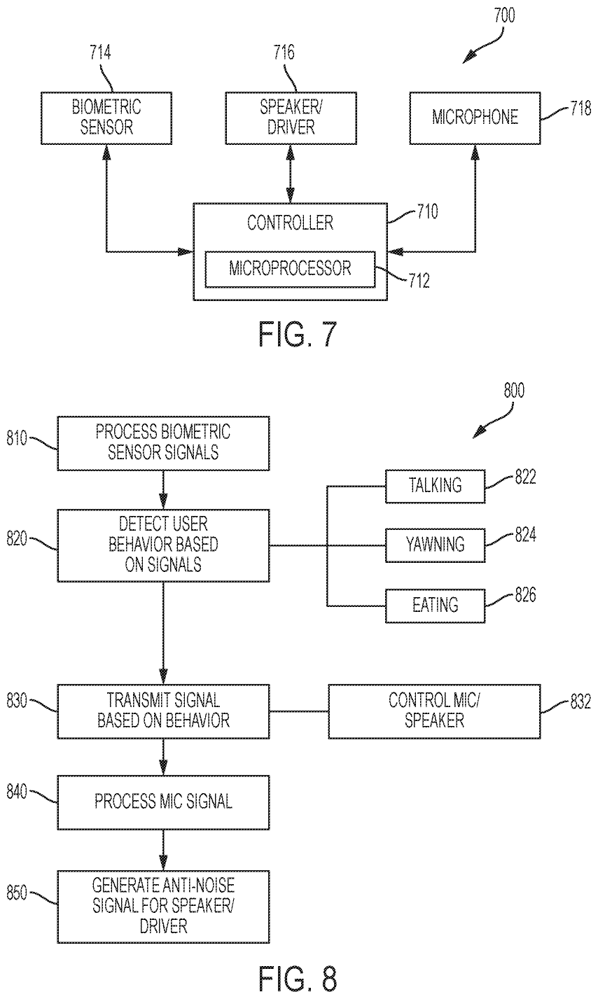

FIGS. 4 and 5 illustrate another embodiment of a headset or earphones according to the present disclosure having an over-the-ear support structure or band. Similar to the embodiment of FIGS. 1 and 3, the embodiment of FIGS. 4 and 5 may include a microphone (not shown), such as a boom microphone that may be connected via a wired or wireless connection to associated electronics and circuitry as generally represented in FIG. 7. Headset 400 includes a band 410 that is configured as an over-the-ear band to fit between the head and helix of the ear of the user. Band 410 is connected to hub 416 via a rotatable connection. Hub 416 may also slide or translate relative to band 410.

As illustrated in FIG. 4, hub 416 is configured similar to a hinge with band 410 functioning as a hinge pin extending through associated apertures of hub 416 and earphone arm 424 to facilitate relative rotation of band 410, hub 416, and earphone arm 424. Hub 416 also supports sensor 442, which may be mounted via a ball-and-socket joint, for example, to facilitate positioning of sensor 442 in contact with a user forward of the tragus of the user within a desired target region. Earphone arm 424 may include an integral housing 464 that may include electronics or circuitry associated with a corresponding speaker (not shown) at least partially surrounded by an elastomeric covering 470. Housing 464 is configured to engage and be supported by the concha of the user with elastomeric covering 470 inserted into the outer portion of the ear canal. Multiple interchangeable elastomeric coverings 470 having different sizes may be provided to allow the user to select an appropriate size for comfort and/or to provide a suitable seal, particularly for ANR applications.

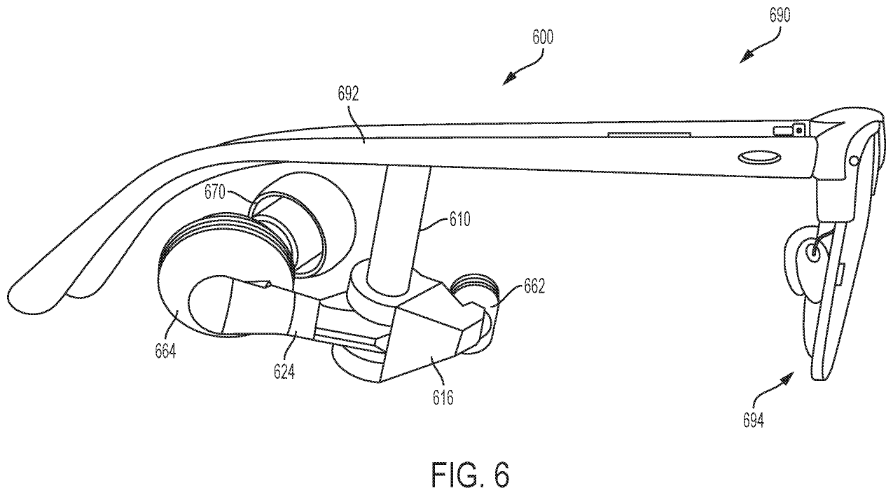

FIG. 6 illustrates another example of a head-mounted adjustable sensor for positioning forward of the tragus of the user according to embodiments of the present disclosure. Similar to previously described embodiments, headset or earphone 600 includes an eyewear post or band 610 configured to be secured to a frame 692 of eyewear 690. Eyewear 690 generally represents any type of eyewear or glasses that may include lenses 694 for safety, fashion, and/or vision correction, for example. Although FIG. 6 illustrates a hub 616 similar to the embodiment of FIGS. 4 and 5, a hub and earphone assemblies similar to those illustrated in the embodiment of FIGS. 1 and 3 may alternatively be secured to frame 692.

Eyewear band 610 may by rotatably connected to hub 616 and earphone support arm 624. Hub 616 may also slide or translate along band 610. Sensor 662 may be connected to hub 616 by a ball-and-socket joint or similar connection. Earphone support arm 624 may be connected to earphone housing 664 that includes an associated earbud and speaker (not show) surrounded by an elastomeric cover 670.

FIG. 7 is a block diagram illustrating operation of a representative control system for a headset having an adjustable sensor according to one or more embodiments. System 700 includes a controller 710, which may include a processor 712. As those of ordinary skill in the art will recognize, a controller 710 may refer to software and/or hardware that cooperate to provide control of the system. Controller 710 and/or processor 712 may be implemented by general purpose or special purpose processors, chips, or microcontrollers, that may include one or more programmable circuits, elements, microprocessors, etc., such as digital signal processors (DSPs), FPGAs, and ASICs, for example. Controller 710 communicates with sensor 714, speaker/driver 716, and microphone 718 via wired and/or wireless communication. Controller 710 may be programmed to perform various functions, features, or algorithms as generally described herein and as represented by flow charts or similar diagrams such as shown in FIG. 8.

FIG. 8 is a flowchart 800 illustrating operation of a system or method for controlling a headset or earphones having an adjustable sensor according to one or more embodiments. The flowchart provides representative control strategies and/or logic that may be implemented using one or more processing strategies such as event-driven, interrupt-driven, multi-tasking, multi-threading, and the like. Various control strategies including, but not limited to, open-loop, closed-loop, adaptive, feedback, feedforward, and hybrid strategies may be implemented by control logic, functions, or software executed by controller 710 to provide active noise reduction, processing of sensor signals to monitor conditions and/or movements of the user, environmental or ambient conditions, and/or processing or analysis of sensor signals to provide an alert or control signal to a local or remote device, such as a microphone or speaker, in various embodiments. Alternatively, sensor data may be transmitted for storage and/or processing at a remote computer, server, or cloud device, for example.

Various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based controller represented by controller 710 and microprocessor 712. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a processor to perform the described function or feature. The computer-readable storage devices or media may include one or more of a number of known physical devices which utilize electric, magnetic, and/or optical storage to keep executable instructions and associated information, operating variables, and the like.

Block 810 represents processing of signals received from a headset-mounted sensor. Signals may be received by a wire connecting the sensor to the processor, or via wireless communication. Signal processing may be performed to monitor one or more physiological parameters of the user, which may be stored in a computer readable storage associated with the controller. Sensor signals from the sensor may also be processed and analyzed to detect user jaw position and/or movement and infer an associated user behavior based on the signals as represented at block 820. For example, jaw position or movement may be analyzed to infer that a user is talking as represented at block 822, yawning as represented at block 824, or eating as represented at block 826.

A signal may be generated in response to detected user behavior and transmitted locally or remotely as represented at block 830. The signal may be used to control an associated microphone or speaker as represented at block 832. In one embodiment, sensor signals are processed to detect user jaw position and/or motion indicative of talking with the resulting signal used to provide a gating signal or automatic attenuation or muting feature for an associated microphone. This is particularly advantageous in noisy environments where automatic muting based on ambient noise levels may lead to spurious unmuting of the microphone. In some embodiments, the signal may be used as a gating signal internally within the controller or processor.

In some embodiments, one or more microphones may be used to monitor ambient noise to provide active noise reduction (ANR), or for use in generating the automatic communication or boom microphone attenuation or muting. In these embodiments, an ambient microphone signal is processed as represented at block 840 to generate an anti-noise signal out of phase with the noise, and apply the anti-noise signal to an associated speaker/driver as represented at block 850.

As apparent from the representative embodiments illustrated, the x-axis and y-axis adjustments can be made by a user adjusting the location of the sensor along a predefined area, either via an adjustable arm that can move along the x-axis, y-axis, or in an eccentric pattern to provide vertical and horizontal or rotational adjustments. The movement along, the axes may involve the entire sensor assembly. Alternatively, or in combination, the movement may involve parts of the assembly, such as a sensor mount or housing. As used herein, references to rotation or pivoting movement may also be provide by a ball-and-socket arrangement.

The z-axis adjustment is limited in user interaction and can be provided by a spring or flexible area, or by rotation of a sensor support arm toward and away from the user, for example, alone or in combination to optimize skin contact, sensor readings, and comfort. The z-axis adjustments account for the ergonomics of the range of heads of users to allow for a proper range of adjustments to be made to optimize skin contact, sensor readings, and comfort.

As demonstrated by the representative embodiments illustrated and described in this disclosure, one or more advantages may be provided. For example, adjustable mounting of a sensor on a headband, over-the-ear band, or eyewear band may allow the user to adjust the position of the sensor relative to the band to improve signal to noise ratio (SNR) and resulting accuracy and reliability of the sensor signal. The headset or earphone may provide isolation for the sensor to reduce the effect of environmental factors, such as ambient noise and light, on the sensor signals. Resilient mounting of a biometric sensor may improve skin contact with the sensor during physical activity, while also improving comfort. Positioning of a biometric sensor in contact with the skin in front of the tragus over at least a portion of the TMJ provides a viable location for measurement of various biometric parameters, such as heartrate, oxygen saturation, blood flow, etc. In addition, positioning of the sensor forward of the tragus using a headset/earphone provides limited location variability from person to person. An adjustable biometric sensor mount according to various embodiments facilitates user adjustment and positioning of the sensor in two dimensions for proper placement with a third-dimension adjustment for comfort and proper skin contact. Detection of jaw movement using a head-mounted sensor may be used to provide an automatic muting, attenuation, or gating function for a communication microphone associated with the headset, or to provide local or remote alerts based on inferred behavior associated with jaw position or movements.

While representative embodiments are described above, it is not intended that these embodiments describe all possible forms of the claimed subject matter. The words used in the specification are words of description rather than limitation, and it is understood that various changes may be made without departing from the spirit and scope of the disclosure. Additionally, the features of various implementing embodiments may be combined to form further embodiments that may not be illustrated or described in combination. While the best mode has been described in detail, those familiar with the art will recognize various alternative designs and embodiments within the scope of the following claims. While various embodiments may have been described as providing advantages or being preferred over other embodiments with respect to one or more desired characteristics, those of ordinary skill in the art will recognize that one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. Any embodiments described as less desirable than other embodiments or prior art implementations with respect to one or more characteristics are not outside the scope of the disclosure and may be desirable for particular applications.

What is claimed is:

1. A headset comprising:
a band;
a hub connected to the band;
an earphone connected to the hub; and
a sensor connected to the hub and configured for movement in at least one direction relative to the hub to be positionable forward of a tragus of a user.

2. The headset of claim 1 wherein further comprising:
a second hub connected to the band;
a second earphone connected to the second hub; and
a second sensor connected to the second hub and configured for movement in at least one direction relative to the hub to be positionable forward of a second tragus of the user.

3. The headset of claim 1 wherein the band is configured for support by a helix of the user.

4. The headset of claim 1 wherein the hand is configured for support by an eyewear frame.

5. The headset of claim 1 further comprising a head support connected to at least one of the hub and the band.

6. The headset of claim 1 further comprising a microphone connected to the hub.

7. The headset of claim 1 wherein the earphone is connected to the hub by an earphone support having an aperture, the hub comprises at least one aperture, and the band extends through the apertures of the earphone support and the hub such that the hub and earphone support are rotatable relative to the band.

8. The headset of claim 1 wherein the sensor is connected to the hub by an extendable arm

9. The headset of claim 8 wherein the sensor is rotatably connected to the extendable arm.

10. The headset of claim 8 wherein the sensor is connected to the extendable arm by a ball-and-socket joint.

11. The headset of claim 1 wherein the earphone is connected to the hub by an extendable arm.

12. The headset of claim 1 wherein the hub is configured to rotate relative to the band.

13. The headset of claim 1 wherein the earphone is connected by an arm to the hub and the arm is configured to rotate relative to the hub.

14. The headset of claim 1 wherein the sensor is connected by an arm to the hub and the arm is configured to rotate relative to the hub.

15. The headset of claim 1 further comprising:
a microphone connected to at least one of the band and the hub; and
a controller coupled to the microphone and the sensor, wherein the controller processes signals from the sensor and the microphone to automatically mute the microphone unless the signals from the sensor indicate jaw movement associated with talking.
